(19) United States
(12) Patent Application Publication
(10) Pub. No.: US 2015/0273980 A1
(43) Pub. Date: Oct. 1, 2015

(54) VEHICULAR HEAT PUMP APPARATUS, AND VEHICULAR AIR CONDITIONING APPARATUS

(71) Applicant: PANASONIC INTELLECTUAL PROPERTY MANAGEMENT CO., LTD., Osaka (JP)

(72) Inventor: Yoshitoshi Noda, Kanagawa (JP)

(21) Appl. No.: 14/441,709

(22) PCT Filed: Nov. 13, 2013
(86) PCT No.: PCT/JP2013/006666

§ 371 Date: May 8, 2015

(30) Foreign Application Priority Data
Nov. 20, 2012 (JP) 2012-254165

(51) Int. Cl. B60H 1/32

(52) U.S. Cl. CPC B60H 1/3204

(57) ABSTRACT

The vehicular heat pump apparatus is provided with: an electric compressor that compresses and discharges an intake refrigerant; a water-refrigerant heat exchanger that can cause heat to be dissipated from a high-temperature, high-pressure refrigerant discharged by the electric compressor to a coolant; a casing that houses the electric compressor and the water-refrigerant heat exchanger; a coolant guiding-in unit that can guide the coolant from outside the casing into the water-refrigerant heat exchanger; a coolant guiding-out unit that can guide the coolant out of the water-refrigerant heat exchanger to the outside of the casing; a single refrigerant guiding-out unit that guides the refrigerant that has passed through the water-refrigerant heat exchanger to the outside of the casing; and a first refrigerant guiding-in unit and a second refrigerant guiding-in unit that guide a low-pressure refrigerant from outside the casing toward the electric compressor.

### TECHNICAL FIELD

The present invention relates to a vehicle heat pump apparatus and a vehicle air-conditioning apparatus.

### BACKGROUND ART

There is an automobile so-called hybrid electric vehicle (HEV) or plug-in hybrid vehicle (PHV) provided with both an internal combustion engine and an electric motor. Typically, a vehicle air-conditioning apparatus mounted in such a vehicle provides heating to a vehicle interior using heat of the internal combustion engine and Joule heat generated by electrical power of a battery.

In addition, an air-conditioning apparatus configured to perform a cooling operation using a heat pump cycle is typically used. The heat pump cycle includes a compressor disposed in an engine compartment; an outside heat exchanger disposed on a front side of a vehicle or at a position in which air can be introduced to the outside heat exchanger; an evaporator disposed on an intake air path of the vehicle interior; an expansion valve; and the like. A high-temperature and high-pressure refrigerant compressed by the compressor is delivered to the outside heat exchanger and is cooled, and the cooled refrigerant is further brought into a low-temperature and low-pressure state by the expansion valve, and is delivered to the evaporator. The evaporator cools air supplied into the vehicle interior. The evaporator is provided in a heating, ventilation, and air conditioning system (hereinafter, referred to as an HVAC system) installed in the vehicle interior.

In the related art, there have been several proposals on a vehicle air-conditioning apparatus that provides heating to the vehicle interior using a heat pump so as not to waste electrical power of the battery (for example, refer to Patent Literature (hereinafter, referred to as “PTL”) 1).

### CITATION LIST

### Patent Literature

### PTL 1

Japanese Patent Application Laid-Open No. HEI 8-197937

### SUMMARY OF INVENTION

### Technical Problem

In the conventional vehicle air-conditioning apparatus which uses the heat pump cycle only during a cooling operation, a refrigerant pipe pattern is relatively simple as described above.

However, there is a problem in that the conventional vehicle air-conditioning apparatus configured to perform a heating operation using the heat pump cycle has a refrigerant pipe pattern quite different from that of the conventional vehicle air-conditioning apparatus configured to use the heat pump cycle only during the cooling operation.

In an automobile, various configuration elements such as an engine, a motor, a transmission, an air-conditioning compressor, and an intake air path are mounted in a small space. Accordingly, the layout flexibility of the components is low.

In the automotive field, a technical improvement is attempted via a so-called minor change in which a configuration is not considerably changed but is partially changed.

The vehicle air-conditioning apparatus may be improved as a minor change of a vehicle, and in this case, the configuration of the vehicle air-conditioning apparatus needs to be modified without affecting other components of the vehicle.

Refrigerant pipes of the vehicle air-conditioning apparatus using the heat pump cycle are installed so as to avoid interference with other components of the vehicle. For this reason, a small change in the refrigerant pipe pattern is a pre-requisite for modifying the vehicle air-conditioning apparatus without affecting other components of the vehicle. Unlike cooling water pipes, for example, the refrigerant pipes are made of aluminum so as to resist a high pressure. For this reason, making a change in the layout of the refrigerant pipes is not an easy task. In addition, a significant change in refrigerant pipes is not favorable because such a change considerably affects the layout of other components of the vehicle.

An object of the present invention is to provide a vehicle heat pump apparatus and a vehicle air-conditioning apparatus each enabling a heating operation using a heat pump cycle without involving a significant change in a refrigerant pipe pattern compared to that of a conventional vehicle air-conditioning apparatus configured to use a heat pump cycle only during a cooling operation.

### Solution to Problem

A vehicle heat pump apparatus according to an aspect of the present invention includes: an electric compressor that compresses a suctioned refrigerant and that discharges the compressed refrigerant; a cooling water-to-refrigerant heat exchanger that is capable of releasing heat to cooling water from a high-temperature and high-pressure refrigerant discharged from the electric compressor; a housing that accommodates the electric compressor and the cooling water-to-refrigerant heat exchanger together; a cooling water introduction section that allows the cooling water to be introduced into the cooling water-to-refrigerant heat exchanger from outside the housing; a cooling water outlet section that allows the cooling water to flow to outside the housing from the cooling water-to-refrigerant heat exchanger; a single refrigerant outlet section that allows the refrigerant which has passed through the cooling water-to-refrigerant heat exchanger to flow to outside the housing; and a first refrigerant introduction section and a second refrigerant introduction section through which a low-pressure refrigerant is introduced from outside the housing and delivered to the electric compressor, in which refrigerant returned to the first refrigerant introduction section and refrigerant returned to the second refrigerant introduction section are both the refrigerant flowing from the refrigerant outlet section.

### Advantageous Effects of Invention

According to the present invention, it is possible not only to perform a cooling operation but also to easily perform a heating operation using a heat pump cycle by connecting the vehicle heat pump apparatus to both the outside heat exchanger and the evaporator via pipes including one refrigerant outlet section and two refrigerant introduction sections. In addition, it is possible to reduce changes in a refrigerant pipe pattern compared to that in a conventional vehicle air-conditioning apparatus which performs the cooling operation using the heat pump cycle.

### BRIEF DESCRIPTION OF DRAWINGS

FIG. 1 is a configuration diagram illustrating a vehicle heat pump apparatus and a vehicle air-conditioning apparatus of an embodiment of the present invention;

FIG. 2 is a diagram illustrating a cooling operation performed in the vehicle air-conditioning apparatus of the embodiment;

FIG. 3 is a diagram illustrating a heating operation performed in the vehicle air-conditioning apparatus of the embodiment;

FIG. 4 is a diagram illustrating changes to refrigerant pipes from a conventional vehicle air-conditioning apparatus; and

FIG. 5 is a configuration diagram illustrating a variation of the vehicle heat pump apparatus according to the embodiment of the present invention.

### DESCRIPTION OF EMBODIMENT

Hereinafter, an embodiment of the present invention will be described in detail with reference to the accompanying drawings.

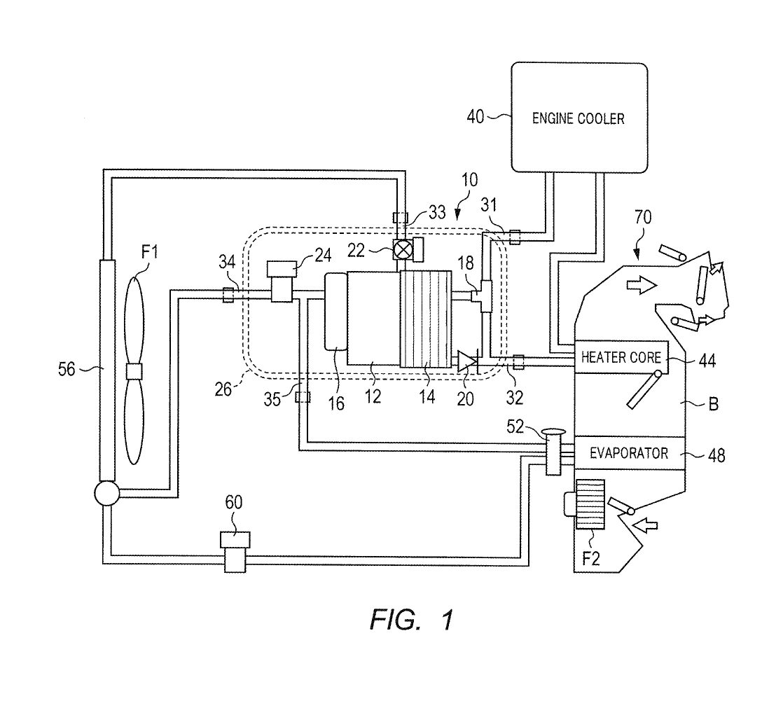

FIG. 1 is a configuration diagram illustrating a vehicle heat pump apparatus and a vehicle air-conditioning apparatus of the embodiment of the present invention.

The vehicle air-conditioning apparatus of the embodiment of the present invention includes: vehicle heat pump apparatus 10; engine cooler 40; heater core 44; evaporator 48; expansion valve 52; outside heat exchanger 56; opening and closing valve 60; and cooling water pipes and refrigerant pipes which connect these components, for example. Heater core 44 and evaporator 48 are included in HVAC system 70 mounted in a vehicle interior. Here, the term “vehicle interior” refers to a space positioned further inward from a fire wall.

Vehicle heat pump apparatus 10 includes electric compressor 12; cooling water-to-refrigerant heat exchanger 14; accumulator 16; three-way valve 18; check valve 20; orifice opening and closing valve 22; opening and closing valve 24; housing 26; cooling water introduction pipe 31; cooling water outlet pipe 32; one refrigerant outlet pipe 33; and two refrigerant introduction pipes 34 and 35.

Electric compressor 12 is electrically driven to compress the suctioned refrigerant to a high-temperature and high-pressure state, and discharges the compressed refrigerant. A suction inlet for the refrigerant in electric compressor 12 communicates with two refrigerant introduction pipes 34 and 35 via accumulator 16, and a refrigerant discharge outlet of electric compressor 12 communicates with an inlet of a refrigerant path of cooling water-to-refrigerant heat exchanger 14.

Cooling water-to-refrigerant heat exchanger 14 has a cooling water path and the refrigerant path, and the cooling water path and the refrigerant path are configured to be in large-area contact with each other so that a large amount of heat exchange can be performed therebetween. An inlet of the refrigerant path communicates with the discharge outlet of electric compressor 12, and an outlet of the refrigerant path communicates with refrigerant outlet pipe 33 provided with orifice opening and closing valve 22. An inlet of the cooling water path is connected to three-way valve 18 via a pipe, and an outlet for the cooling water is connected to check valve 20 via a pipe.

The high-temperature and high-pressure refrigerant flows through cooling water-to-refrigerant heat exchanger 14 while electric compressor 12 is driven, and in contrast, the cooling water is made to flow or not to flow through cooling water-to-refrigerant heat exchanger 14 by the switching of three-way vale. When the cooling water flows through cooling water-to-refrigerant heat exchanger 14, heat is radiated from the high-temperature and high-pressure refrigerant to the cooling water, and when the cooling water does not flow, the high-temperature and high-pressure refrigerant passes through cooling water-to-refrigerant heat exchanger 14 while maintaining substantially the same high temperature.

Three-way valve 18 is switched by electric control to allow the cooling water to flow from cooling water introduction pipe 31 to either one of cooling water-to-refrigerant heat exchanger 14 and cooling water outlet pipe 32.

Check valve 20 prevents a reverse flow of the cooling water to cooling water-to-refrigerant heat exchanger 14.

In the embodiment, three-way valve 18 and check valve 20 correspond to cooling-water flow switching valves that switches the flow path of the cooling water between a flow path formed to bypass cooling water-to-refrigerant heat exchanger 14 and a flow path connected to cooling water-to-refrigerant heat exchanger 14.

Orifice opening and closing valve 22 is an opening and closing valve configured to work as an expansion valve during a heating operation, and is electrically controlled to switch between an open state and a closed state. For example, orifice opening and closing valve 22 has a large-diameter path and an orifice made up of a small-diameter path, and the large-diameter path is configured to be openable and closeable. When the large-diameter path is opened, orifice opening and closing valve 22 allows the refrigerant to pass therethrough, and when the large-diameter path is closed and only the path of the orifice is open, a high-pressure refrigerant expands via the small-diameter path. The expanded refrigerant becomes a low-temperature and low-pressure refrigerant.

Opening and closing valve 24 is equivalent to a switching valve that switches a refrigerant introduction path between two refrigerant introduction pipe 34 and 35. Opening and closing valve 24 is provided between an inlet of refrigerant introduction pipe 34 and a junction of two refrigerant introduction pipes 34 and 35, and is electrically controlled to open and close a path between the inlet and the junction.

Accumulator 16 separates a gaseous refrigerant from a liquefied refrigerant, and delivers only the gaseous refrigerant to electric compressor 12.

Each of three-way valve 18, orifice opening and closing valve 22, and opening and closing valve 24 switches between an open state and a closed state in response to an electric signal transmitted from a control apparatus of the vehicle air-conditioning apparatus. Alternatively, each of three-way valve 18, orifice opening and closing valve 22, and opening and closing valve 24 may be configured to switch between an open state and a closed state in response to a signal that is output by the control section of vehicle heat pump apparatus 10 based on a command from the control apparatus of the vehicle air-conditioning apparatus.

Housing 26 accommodates electric compressor 12, cooling water-to-refrigerant heat exchanger 14, accumulator 16, three-way valve 18, check valve 20, orifice opening and closing valve 22, and opening and closing valve 24, and integrates these components into a single package. The surrounding of housing 26 may be insulated, and electric compressor 12 and cooling water-to-refrigerant heat exchanger 14 may be closely disposed so as to enable heat exchange between the two in the housing 26.

Refrigerant outlet pipe 33 and two refrigerant introduction pipes 34 and 35 are respectively equivalent to a refrigerant outlet section and refrigerant introduction sections of vehicle heat pump apparatus 10. An end of each of refrigerant outlet pipe 33 and refrigerant introduction pipes 34 and 35 is exposed to outside housing 26, and is connected to the refrigerant pipes of the vehicle air-conditioning apparatus. A connector or a socket for pipe connection may be provided at the end of each of refrigerant outlet pipes 33 and refrigerant introduction pipes 34 and 35.

Cooling water introduction pipe 31 and cooling water outlet pipe 32 are respectively equivalent to a cooling water introduction section and a cooling water outlet section of vehicle heat pump apparatus 10. An end of each of cooling water introduction pipe 31 and cooling water outlet pipe 32 is exposed to outside housing 26, and is connected to the cooling water pipes of the vehicle air-conditioning apparatus. The end of each of cooling water introduction pipe 31 and cooling water outlet pipe 32 may be provided with a connector or a socket for pipe connection.

Engine cooler 40 includes a water jacket provided in the internal combustion engine so as to allow the cooling water to flow therethrough, and a pump that makes the cooling water flow through the water jacket. Heat is radiated from the internal combustion engine to the cooling water flowing through the water jacket. An inlet and an outlet of a cooling water path of the water jacket communicate respectively to heater core 44 and cooling water introduction pipe 31 of vehicle heat pump apparatus 10.

Heater core 44 is a section in which the cooling water exchanges heat with air, and is disposed in intake air path B of HVAC system 70, through which air is supplied to the vehicle interior. A cooling water path of heater core 44 communicates with engine cooler 40 and cooling water outlet pipe 32 of vehicle heat pump apparatus 10. Fan F2 introduces outside air or the like to intake air path B of HVAC system 70.

Evaporator 48 is a section in which the refrigerant expanded to a low-temperature and low-pressure state exchanges heat with air, and is disposed in intake air path B of HVAC system 70. When the refrigerant expanded to a low-temperature and low-pressure state passes through evaporator 48, the low-temperature and low-pressure refrigerant evaporates by absorbing heat from air. An inlet of a refrigerant path of evaporator 48 communicates with outside heat exchanger 56 via a pipe while expansion valve 52 and opening and closing valve 60 are interposed between the inlet and outside heat exchanger 56. An outlet of the refrigerant path of evaporator 48 communicates with refrigerant introduction pipe 35 of the vehicle heat pump apparatus via pipes.

Expansion valve 52 allows a high-pressure refrigerant to expand to a low-temperature and low-pressure state, and discharges the low-temperature and low-pressure refrigerant to evaporator 48. Expansion valve 52 is disposed outside vehicle heat pump apparatus 10, and is connected to the vicinity of evaporator 48.

Outside heat exchanger 56 has a refrigerant flow path and an air flow path, and is disposed in the vicinity of the forefront of vehicle in the engine compartment, and in outside heat exchanger 56, the refrigerant flowing through the path exchanges heat with outside air. An inlet of the refrigerant path of outside heat exchanger 56 communicates with refrigerant outlet pipe 33 of vehicle heat pump apparatus 10 via a pipe. An outlet of the refrigerant path branches into two pipes in the middle of the path, and the two pipes communicate respectively to evaporator 48 and refrigerant introduction pipe 34 of vehicle heat pump apparatus 10.

During a heating operation, a low-temperature and low-pressure refrigerant flows through outside heat exchanger 56 and absorbs heat from outside air, and during a cooling operation, a high-temperature and high-pressure refrigerant flows through outside heat exchanger 56, and heat is radiated from a high-temperature and high-pressure refrigerant to outside air. For example, fan Fl blows outside air against outside heat exchanger 56.

Opening and closing valve 60 is provided in the middle of the pipe through which the refrigerant flows from outside heat exchanger 56 to evaporator 48, and is electrically controlled to open and close the pipe.

[Cooling Operation]

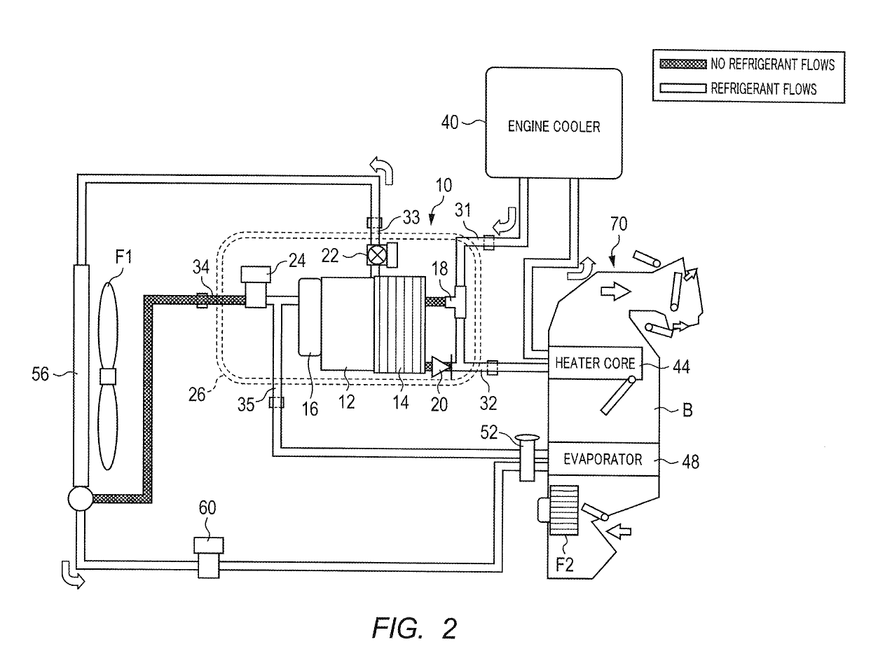

FIG. 2 is a diagram illustrating a cooling operation performed by the vehicle air-conditioning apparatus of the embodiment. Hatched portions of pipes illustrated in FIG. 2 indicate that the refrigerant or the cooling water does not flow through the hatched portions.

During the cooling operation, opening and closing valve 24 is switched to close, opening and closing valve 60 is switched to open, orifice opening and closing valve 22 is switched to open, and a port of three-way valve 18 connected to cooling water-to-refrigerant heat exchanger 14 is switched to close.

Due to switching, the cooling water circulates through engine cooler 40 and heater core 44, and in contrast, the cooling water does not flow to cooling water-to-refrigerant heat exchanger 14. Since an air mixture damper in intake air path B of HVAC system 70 is switched in order for air not to flow to heater core 44, ventilation air supplied to the vehicle interior is not heated.

After the refrigerant is compressed to a high-temperature and high-pressure state by electric compressor 12, the high-temperature and high-pressure refrigerant passes through cooling water-to-refrigerant heat exchanger 14 while maintaining a high temperature, and is delivered to outside heat exchanger 56. Thereafter, the refrigerant is cooled in outside heat exchanger 56, and then the cooled refrigerant expands to a low-temperature and low-pressure state while passing through expansion valve 52, and then is delivered to evaporator 48. In evaporator 48, the refrigerant absorbs heat from air to be delivered to the vehicle interior, the air is cooled and the refrigerant evaporates. The evaporated refrigerant returns to electric compressor 12 via accumulator 16.

It is possible to deliver cooled air to the vehicle interior via such a heat pump cycle.

[Heating Operation]

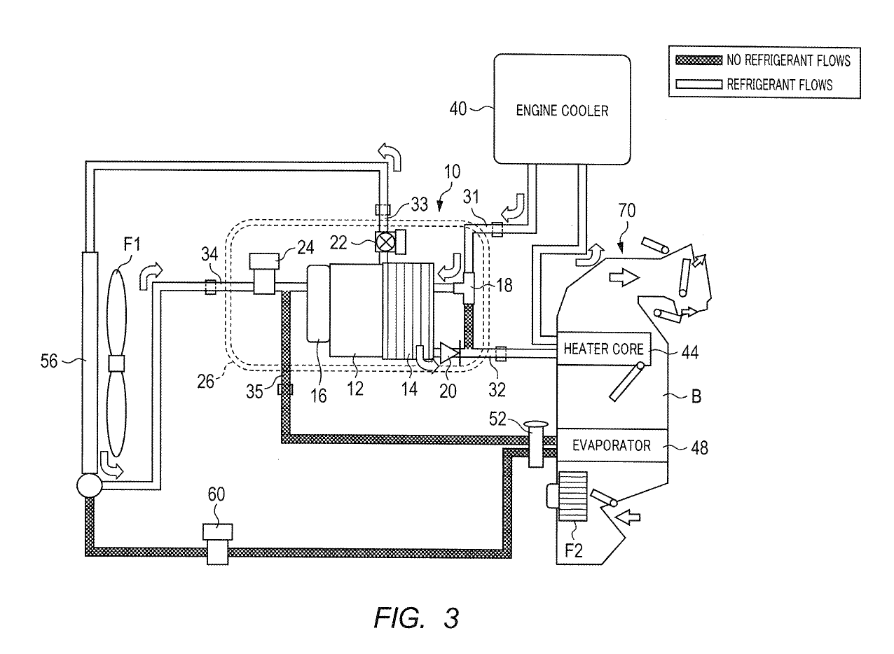

FIG. 3 is a diagram illustrating a heating operation performed by the vehicle air-conditioning apparatus of the embodiment. Hatched potions of pipes illustrated in FIG. 3 indicate that the refrigerant or the cooling water does not flow through the hatched portions.

During the heating operation, opening and closing valve 24 is switched to open, opening and closing valve 60 is switched to close, orifice opening and closing valve 22 is switched to close, and a port of three-way valve 18 connected to cooling water outlet pipe 32 is switched to close.

Due to switching, the cooling water circulates through engine cooler 40, cooling water-to-refrigerant heat exchanger 14, and heater core 44. During the circulation, the cooling water is heated in engine cooler 40 and cooling water-to-refrigerant heat exchanger 14, and in heater core 44, heat is radiated from the cooling water to air flowing through intake air path B of HVAC system 70.

In vehicle heat pump apparatus 10, heat generated by electric compressor 12 is transferred to the cooling water in cooling water-to-refrigerant heat exchanger 14, and the heat discharged from electric compressor 12 is also used as a heat source.

The air mixture damper in intake air path B is switched to allow air to flow to heater core 44, and air to be delivered to the vehicle interior is warmed.

After the refrigerant is compressed to a high-temperature and high-pressure state by electric compressor 12, the high-temperature and high-pressure refrigerant radiates heat to the cooling water while passing through cooling water-to-refrigerant heat exchanger 14. After heat is radiated, the high-pressure refrigerant expands to a low-temperature and low-pressure state while passing through orifice opening and closing valve 22, and is delivered to outside heat exchanger 56. In outside heat exchanger 56, the refrigerant absorbs heat from outside air, and the refrigerant evaporates. The evaporated refrigerant returns to electric compressor 12 via accumulator 16. The refrigerant does not flow through evaporator 48, and heat exchange is not performed in evaporator 48.

It is possible to deliver warm air to the vehicle interior via such an operation. Heat from the engine is effectively used so as to warm air, and a shortage of the engine heat is supplemented by using the heat pump cycle. In addition, heat discharged from electric compressor 12 is effectively used to warm air. Since the heat pump cycle is used for air heating, it is possible to reduce power consumption per the amount of heating.

[Comparison Between Pipe Paths]

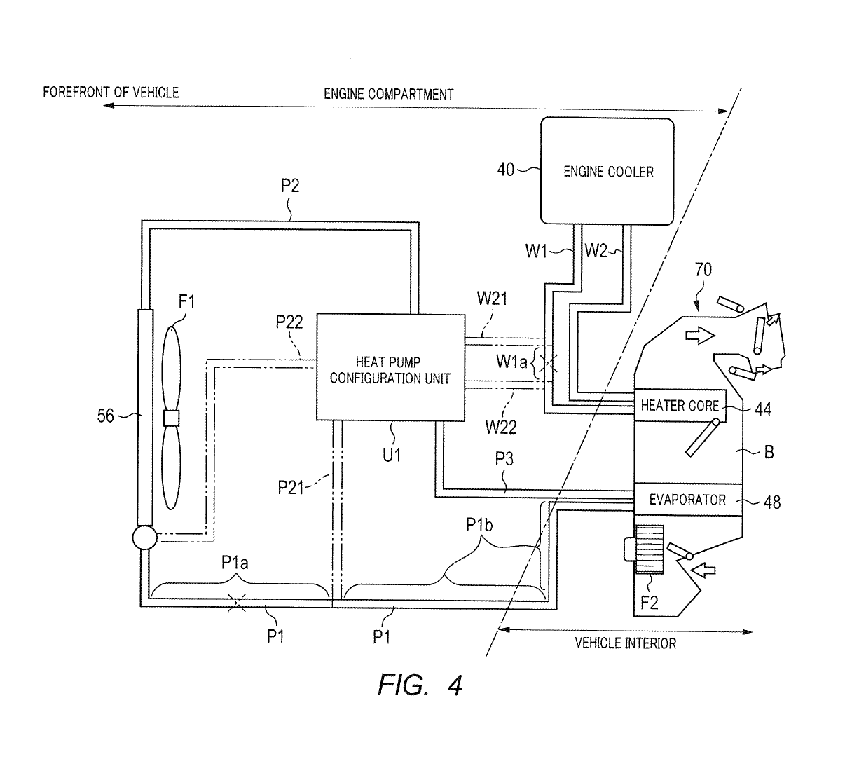

FIG. 4 is a diagram illustrating changes to the refrigerant pipes from the conventional vehicle air-conditioning apparatus. In FIG. 4, solid lines indicate pipes of the conventional vehicle air-conditioning apparatus.

[Regarding Conventional Vehicle Air-conditioning Apparatus]

In the conventional vehicle air-conditioning apparatus which uses the heat pump cycle only during the cooling operation, outside heat exchanger 56 is disposed in the vicinity of the forefront of vehicle in the engine compartment, and intake air path B, heater core 44, and evaporator 48 are disposed in HVAC system 70 provided in the vehicle interior. Configuration unit U1 of the heat pump cycle is disposed in the engine compartment. In this case, configuration unit U1 is a compressor that compresses a refrigerant.

In this configuration, refrigerant pipes are illustrated by solid lines in FIG. 4. That is, The refrigerant pipes are made up of only three pipes: pipe P1 running from outside heat exchanger 56 at the forefront of vehicle in the engine compartment to evaporator 48 in the vehicle interior; pipe P2 running from the configuration unit (compressor) U1 in the engine compartment to outside heat exchanger 56; and pipe P3 running from evaporator 48 in the vehicle interior to the configuration unit (compressor) U1 in the engine compartment.

While avoiding collision with other components of the vehicle, each of pipes P1 to P3 is routed on a straight path as much as possible in order for the refrigerant not to undergo a large pressure loss. In particular, the layout of pipe P1 to be installed over a long range is preferentially designed to be a straight path as much as possible.

Cooling water pipes W1 and W2 are installed between engine cooler 40 in the engine compartment and heater core 44 in HVAC system 70.

### Example in which Many Changes are Made to Refrigerant Pipes

In the air-conditioning apparatus configured to perform the heating operation using the heat pump cycle, a case given hereinbelow is studied based on the condition that the configuration of intake air path B in HVAC system 70 and a configuration in the engine compartment are not much changed.

In this case, first, configuration unit U1 of the heat pump cycle disposed in the engine compartment is configured to include a compressor that compresses the refrigerant, and a cooling water-to-refrigerant heat exchanger in which heat is radiated from the compressed high-temperature refrigerant to the cooling water. The cooling water-to-refrigerant heat exchanger is required so as to provide heated cooling water to heater core 44 that warms air in intake air path B in HVAC system 70.

Pipes W21 and W22 are provided between configuration unit U1 and heater core 44, and the heated cooling water circulates through pipes W21 and W22. Partial pipe W1a of pipe W1 communicating with engine cooler 40 is cut off, and pipes W21 and W22 are connected to vehicle heat pump apparatus 10 so as to bypass partial pipe W1a.

In this study, when no specific scheme to reduce the changes to the pipes is implemented, refrigerant pipes having different functions are respectively provided between configuration unit U1 and evaporator 48 and between configuration unit U1 and outside heat exchanger 56.

That is, outflow pipes P21 and P1b, and return flow pipe P3 are provided between configuration unit U1 and evaporator 48, and a low-temperature refrigerant flows through the outflow pipes P21 and P1b. In addition, outflow pipe P2 and return flow pipe P22 for discharging heat to the outside (during cooling operation) and absorbing heat from the outside (during heating operation) are provided between configuration unit U1 and outside heat exchanger 56. For example, a unit and an air-conditioning system disclosed in PTL 1 has the aforementioned configuration (refer to FIGS. 21 to 24 in PTL 1).

At this time, the following changes are made to the conventional pipes: two refrigerant pipes P21 and P22 are added, and partial pipe P1a of long pipe P1 provided over the engine compartment is removed.

Since a low-temperature refrigerant flows through pipe P21 disposed in the engine compartment under a high temperature condition, it is necessary to considerably improve insulation for pipe P21, and to dispose configuration unit U1 close to evaporator 48.

### Regarding Embodiment

In contrast, as can be seen from the comparison between FIG. 1 and FIG. 4, the configuration of the embodiment is obtained only by making the following change to the refrigerant pipes of the conventional vehicle air-conditioning apparatus: only one refrigerant pipe P22 is added.

In the configuration of the embodiment, since expansion valve 52 can be disposed immediately ahead of evaporator 48, the pipe through which a low-temperature and low-pressure refrigerant is supplied to evaporator 48 is prevented from being disposed in the engine compartment and undergoing a large heat loss.

As such, in vehicle heat pump apparatus 10 and the vehicle air-conditioning apparatus of the embodiment, the change in the refrigerant pipe pattern is minimized compared to the conventional vehicle air-conditioning apparatus which uses the heat pump cycle only during the cooling operation. In the embodiment, it is possible to perform the heating operation using the heat pump cycle.

Accordingly, the embodiment is particularly effective for a case where the conventional vehicle air-conditioning apparatus originally mounted in a vehicle is replaced with the vehicle air-conditioning apparatus capable of performing the heating operation using the heat pump cycle via a minor change or an optional change. That is, when only a space for additional refrigerant pipe P22 is provided, it is possible to apply the vehicle air-conditioning apparatus of the embodiment without affecting the layout of other components of the vehicle.

Typically, since the flow rate of a liquid refrigerant (liquefied refrigerant) is low in a pipe exclusively designed for refrigerant, a pipe having a small pipe diameter is adopted (for example, an outer diameter of 8 mm). In contrast, it is necessary to increase the pipe diameter of a pipe between the expansion valve and the evaporator (for example, an outer diameter of 12 mm).

In the conventional vehicle air-conditioning apparatus, the expansion valve is provided immediately ahead of evaporator 48, pipe P from outside heat exchanger 56 to a point immediately ahead of evaporator 48 adopts a small pipe diameter.

In a case where the vehicle air-conditioning apparatus is changed to a system in which a low-temperature refrigerant is supplied from configuration unit U1 to evaporator 48, since the expansion valve is built into configuration unit U1, pipes P21 and P1b between configuration unit U1 and evaporator 48 are required to have a large pipe diameter. In this case, a change required to be made to the conventional pipes is that the pipe diameter of part (pipe P1b) of originally installed pipe P1 is increased.

In contrast, in the vehicle air-conditioning apparatus of the embodiment, the expansion valve is provided immediately ahead of evaporator 48, and thereby it is no longer necessary to increase the pipe diameter of pipe P1.

[Variation]

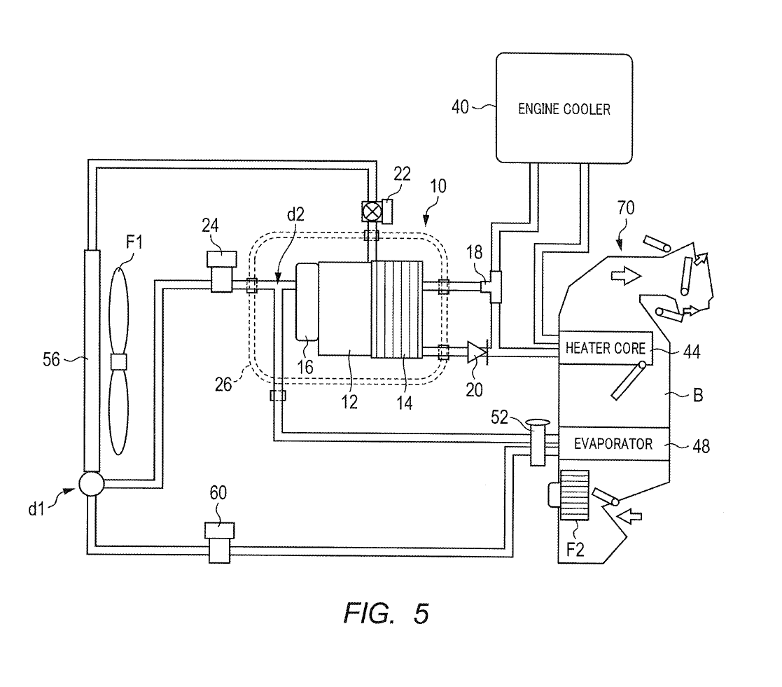

FIG. 5 is a configuration diagram illustrating a variation of the vehicle heat pump apparatus according to the embodiment of the present invention.

As illustrated in FIG. 5, vehicle heat pump apparatus 10 according to the embodiment of the present invention may have the entirety or any one of the following valves provided outside housing 26: opening and closing valve 24; orifice opening and closing valve 22; three-way valve 18; and check valve 20.

Two opening and closing valves 24 and 60 can be replaced with a three-way valve that is provided at branch locations d1 and d2 of the refrigerant pipe.

The configuration in which the cooling water is allowed to flow while bypassing cooling water-to-refrigerant heat exchanger 14 or via cooling water-to-refrigerant heat exchanger 14 is not limited to the configuration in which three-way valve 18 and check valve 20 are used, and a plurality of opening and closing valves can be configured.

The embodiment of the present invention has been described thus far.

In the embodiment, a pipe is configured as a refrigerant introduction section or a refrigerant outlet section of vehicle heat pump apparatus 10; however, the refrigerant introduction section or the refrigerant outlet section may be configured as a connector or a socket for pipe connection embedded in a wall of housing 26. Similarly, the cooling water introduction section or the cooling water outlet section may be configured as a connector or a socket for pipe connection embedded in a wall of housing 26.

In the configuration described in the embodiment, the cooling water absorbing heat from the internal combustion engine is supplied to the heater core; however, a configuration in which the cooling water flows from only vehicle heat pump apparatus 10 to heater core 44 may be adopted.

A new vehicle air-conditioning apparatus and a new vehicle heat pump apparatus of the embodiment may be mounted in a vehicle. The vehicle heat pump of the embodiment may be replaced with a part of the conventional vehicle air-conditioning apparatus which uses the heat pump cycle only during the cooling operation illustrated in FIG. 4. By virtue of the replacement, it is possible to realize the vehicle air-conditioning apparatus of the embodiment, and to perform the heating operation using the heat pump cycle.

The disclosure of Japanese Patent Application No. 2012-254165, filed on Nov. 20, 2012, including the specification, drawings and abstract is incorporated herein by reference in its entirety.

### INDUSTRIAL APPLICABILITY

The present invention can be applied to a vehicle heat pump apparatus and a vehicle air-conditioning apparatus each configured to be mounted in a vehicle.

### REFERENCE SIGNS LIST

10 Vehicle heat pump apparatus
12 Electric compressor
14 Cooling water-to-refrigerant heat exchanger
16 Accumulator
18 Three-way valve
20 Check valve
22 Orifice opening and closing valve
24 Opening and closing valve
26 Housing
31 Cooling water introduction pipe
32 Cooling water outlet pipe
33 Refrigerant outlet pipe
34, 35 Refrigerant introduction pipe
40 Engine cooler
44 Heater core
48 Evaporator
52 Expansion valve
56 Outside heat exchanger
60 Opening and closing valve
B Intake air path
F1, F2 Fan

1. A vehicle heat pump apparatus comprising:
an electric compressor that compresses a suctioned refrigerant and that discharges the compressed refrigerant;
a cooling water-to-refrigerant heat exchanger that is capable of releasing heat to cooling water from a high-temperature and high-pressure refrigerant discharged from the electric compressor;
a housing that accommodates the electric compressor and the cooling water-to-refrigerant heat exchanger together;
a cooling water introduction section that allows the cooling water to be introduced into the cooling water-to-refrigerant heat exchanger from outside the housing;
a cooling water outlet section that allows the cooling water to flow to outside the housing from the cooling water-to-refrigerant heat exchanger;
a single refrigerant outlet section that allows the refrigerant which has passed through the cooling water-to-refrigerant heat exchanger to flow to outside the housing; and
a first refrigerant introduction section and a second refrigerant introduction section through which a low-pressure refrigerant is introduced from outside the housing and delivered to the electric compressor, wherein
refrigerant returned to the first refrigerant introduction section and refrigerant returned to the second refrigerant introduction section are both the refrigerant flowing from the refrigerant outlet section.

2. The vehicle heat pump apparatus according to claim 1, further comprising a switching valve that switches an introduction path of the low-pressure refrigerant between the first refrigerant introduction section and the second refrigerant introduction section.

3. The vehicle heat pump apparatus according to claim 2, further comprising an opening and closing valve having an expansion valve function, the valve being capable of switching between delivering the high-pressure refrigerant that has passed through the cooling water-to-refrigerant heat exchanger to the refrigerant outlet section while causing the refrigerant to expand, and delivering the high-pressure refrigerant while keeping the refrigerant in a high pressure state.

4. The vehicle heat pump apparatus according to claim 3, wherein the housing accommodates the switching valve and the opening and closing valve having the expansion valve function.

5. The vehicle heat pump apparatus according to claim 1, further comprising a cooling-water flow switching valve that is capable of switching between delivering the cooling water introduced from the cooling water introduction section to the cooling water outlet section via the cooling water-to-refrigerant exchanger, and delivering the cooling water to the cooling water outlet section without intervention of the cooling water-to-refrigerant heat exchanger, wherein
the housing accommodates the cooling-water flow switching valve.

6. The vehicle heat pump apparatus according to claim 1, further comprising an accumulator that is disposed on a refrigerant suction side of the electric compressor, wherein
the housing accommodates the accumulator.

7. The vehicle heat pump apparatus according to claim 1, wherein the vehicle heat pump apparatus enables a heating operation using a heat pump cycle by being partially replaced with a part of a vehicle air-conditioning apparatus that uses a heat pump cycle only during a cooling operation.

8. A vehicle air-conditioning apparatus comprising:
an internal combustion engine cooler that causes cooling water to absorb heat from an internal combustion engine of a vehicle;
a heat exchanger for heating that causes heat to be released from high-temperature cooling water to air which is delivered to a vehicle interior;
an evaporator that causes a low-temperature refrigerant to absorb heat from air which is delivered to the vehicle interior;
an outside heat exchanger that allows the refrigerant to exchange heat with air outside the vehicle interior; and
the vehicle heat pump apparatus according to claim 1, wherein
the internal combustion engine cooler and the heat exchanger for heating are connected to each other in series between the cooling water outlet section and the cooling water introduction section of the vehicle heat pump apparatus,
the outside heat exchanger and the evaporator are connected to each other in series between the refrigerant outlet section of the vehicle heat pump apparatus and the first refrigerant introduction section, and
a refrigerant path between the outside heat exchanger and the evaporator branches out and is connected to the second refrigerant introduction section.

9. The vehicle air-conditioning apparatus according to claim 8, further comprising an expansion valve that delivers a high-pressure refrigerant to the evaporator while causing the high-pressure refrigerant to expand, wherein
the expansion valve is disposed outside the vehicle heat pump apparatus and on an upstream side of the evaporator.

10. The vehicle air-conditioning apparatus according to claim 9, further comprising an opening and closing valve that is capable of opening and closing the refrigerant path between the outside heat exchanger and the evaporator.
